(19) United States
(12) Patent Application Publication
(10) Pub. No.: US 2025/0287187 A1
(43) Pub. Date: Sep. 11, 2025

(54) SYSTEM AND METHOD FOR COMMUNICATING TRAFFIC CONDITIONS SURROUNDING A VEHICLE ON A ROAD

(71) Applicant: Torc Robotics, Inc., Blacksburg, VA (US)

(72) Inventors: William Davis, Blacksburg, VA (US); Akshay Pai Raikar, Blacksburg, VA (US); Joseph R. Fox-Rabinovitz, Blacksburg, VA (US)

(21) Appl. No.: 18/596,464

(22) Filed: Mar. 5, 2024

(51) Int. Cl. H04W 4/46; G06K 19/06; G06V 20/56; G08G 1/01

(52) U.S. Cl. CPC H04W 4/46; G06K 19/06037; G06V 20/56; G08G 1/0112

(57) ABSTRACT

A vehicle includes a vehicle wireless communication equipment, a perception system including a plurality of sensors, an indicium for connecting to the vehicle wireless communication equipment. The wireless communication equipment is configured to establish a session with a third-party client device and receive a request from the third-party client device to receive personalized or custom traffic condition information based upon a specific position identified of a second vehicle associated with the third-party client device. At least one processor of the perception system is configured to generate the personalized or custom traffic condition information corresponding to the specific position of the second vehicle based upon sensor data of the plurality of sensors of the perception system, and initiate transmission of the personalized or custom traffic condition information corresponding the specific position of the second vehicle to the third-party client device via the vehicle wireless communication equipment over the established session.

### TECHNICAL FIELD

The field of the disclosure relates generally to an on-vehicle radio system and a perception system and, more specifically, to an on-vehicle radio system, such as a Wi-Fi system, for communication of traffic conditions surrounding a vehicle as sensed by a perception system of an autonomous vehicle in proximity of the vehicle.

### BACKGROUND

Often while driving on a multi-lane highway during peak hours, a driver of a vehicle may perceive that other lanes are moving faster, and he or she should move over to the next lane that appears to be moving faster. However, in most cases, soon after switching lanes, the driver may perceive that the original driving lane was better and was moving faster. The frequent driving lane changes by the drivers therefore may pose a risk of accidents and frustration to many drivers. Accordingly, there is a need of solutions that provide drivers information, as a courtesy, about traffic conditions surrounding their vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a vehicle is disclosed. The vehicle including a vehicle wireless communication equipment, a perception system, and an indicium for connecting to the vehicle wireless communication equipment is disclosed. The perception system includes at least one processor, at least one memory configured to store instructions, and a plurality of sensors positioned, or mounted, on a body of the vehicle. The wireless communication equipment is configured to: (i) broadcast a network identifier of the vehicle wireless communication equipment; (ii) receive a request, from a third-party client device, to connect with the vehicle wireless communication equipment based upon the broadcasted network identifier or the indicium for connecting to the vehicle wireless communication equipment; (iii) in response to the received request, establish a session with the third-party client device; and (iv) receive a request from the third-party client device to receive personalized or custom traffic condition information based upon a specific position identified of a second vehicle associated with the third-party client device. The at least one processor of the perception system is configured to: (i) based upon sensor data of the plurality of sensors of the perception system, generate the personalized or custom traffic condition information corresponding to the specific position of the second vehicle; and (ii) initiate transmission of the personalized or custom traffic condition information corresponding the specific position of the second vehicle to the third-party client device via the vehicle wireless communication equipment over the established session.

In another aspect, a method of transmitting personalized or custom traffic condition information from a vehicle to a client device is disclosed. The method includes: (i) broadcasting a network identifier of a wireless communication equipment installed in the vehicle; (ii) receiving a request, from the client device, to connect with the wireless communication equipment based upon the broadcasted network identifier or scanning of an indicium displayed on a body of the vehicle by the client device; (iii) in response to receiving the request, establishing a session with the client device; (iv) receiving a request from the client device for personalized or custom traffic condition information based upon a specific position identified of a second vehicle associated with the client device; (v) based upon sensor data of a plurality of sensors of a perception system of the vehicle, generating the personalized or custom traffic condition information corresponding to the specific position of the second vehicle; and (vi) transmitting, to the client device, the personalized or custom traffic condition information over the established session.

In yet another aspect, a vehicle including a vehicle wireless communication equipment, at least one processor, at least one memory configured to store instructions, a plurality of perception sensors positioned or mounted on a body of the vehicle, and an indicium for connecting to the vehicle wireless communication equipment is disclosed. The indicium is displayed on the body of the vehicle and the indicium includes or represents information to connect with the vehicle wireless communication equipment. The vehicle wireless communication equipment is configured to: (i) broadcast a network identifier of the vehicle wireless communication equipment; (ii) receive a request, from a third-party client device, to connect with the vehicle wireless communication equipment based upon the broadcasted network identifier or the indicium for connecting to the vehicle wireless communication equipment; (iii) in response to the received request, establish a session with the third-party client device; and (iv) receive a request from the third-party client device to receive personalized or custom traffic condition information based upon a specific position identified of a second vehicle associated with the third-party client device. The at least one processor is configured to execute the stored instructions to: (i) based upon sensor data of the plurality of perception sensors, generate the personalized or custom traffic condition information corresponding to the specific position of the second vehicle; and (ii) cause transmission of the personalized or custom traffic condition information corresponding the specific position of the second vehicle to the third-party client device via the vehicle wireless communication equipment over the established session.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of a vehicle such as a truck that includes an infotainment broadcast system of an exemplary embodiment of the present disclosure;

FIG. 2 is an exemplary schematic block diagram of a computing device for implementation of embodiments of the present disclosure;

FIG. 3 is a block diagram of a perception system;

FIG. 4 is an exemplary view of a visual representation displayed in a graphical user interface of a frontend application executing on a user equipment; and

FIG. 5 is an exemplary flow chart of a method of transmitting infotainment information from a vehicle to a client device in accordance with embodiments of the present disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, or steering wheel positioning, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane or parking the vehicle without human intervention. A semi-autonomous vehicle has an autonomy level of level-1, level-2, or level-3 recognized by NHTSA. The semi-autonomous vehicle requires a human driver at all times for operating the semi-autonomous vehicle.

A non-autonomous vehicle: A non-autonomous vehicle is a vehicle that is driven by a human driver. A non-autonomous vehicle is neither an autonomous vehicle nor a semi-autonomous vehicle. A non-autonomous vehicle has an autonomy level of level-0 recognized by NHTSA.

A smart vehicle: A smart vehicle is a vehicle installed with on-board computing devices, one or more sensors, one or more controllers, or one or more internet-of-things (IoT) devices which enables the vehicle to receive or transmit data to another vehicle or a server.

Network identifier: A network identifier is an identifier of the on-vehicle radio system (also referenced herein as a wireless communication equipment). The network identifier may be a service set identifier (SSID), a particular frequency or a frequency band, a device name, etc., based on the wireless protocol being used by the wireless communication equipment.

Service Set Identifier (SSID): A SSID is a unique sequence of numbers or letters identifying a name of a Wi-Fi network to connect with the Wi-Fi network.

Infotainment: Infotainment referenced in the present disclosure refers to information including navigation information, traffic conditions, intent of changing a lane or exiting a highway, etc., and entertainment including streaming of music, movies, shows, news, games, puzzles, etc.

An infotainment broadcast system: An infotainment broadcast system includes wireless communication equipment. In one example, the wireless communication equipment may include a Wi-Fi Hotspot or a Wi-Fi network system broadcasting its service set identifier (SSID) and accepting connection requests from other user equipment or vehicles to establish a connection with the infotainment broadcast system to provide infotainment to other user equipment or vehicles connected to the infotainment broadcast system. In another example, the wireless communication equipment may be an amplitude-modulation (AM) radio, a frequency modulation (FM) radio, or a satellite radio broadcasting infotainment service. Thus, the infotainment broadcast system may support one-way transmission or broadcasting of infotainment services or two-way communication with other connected user equipment or vehicles.

As described in the present disclosure, often while driving on a multi-lane highway during peak hours, a driver of a vehicle may feel that other lanes but his or her lane is moving faster, and he or she should move over to the next lane that appears to be moving faster. However, in most cases, soon after switching lane, the driver may feel that the original driving lane was better and was moving faster. The frequent driving lane changes by the drivers may increase the risk of accidents and frustration to many drivers.

However, an autonomous vehicle generally employs fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Additionally, or alternatively, current position and movement of objects in the autonomous vehicle's environment may also be identified. In some embodiments, and by way of a non-limiting example, perception technology employed by the autonomous vehicle may include sensors like a camera, a radio detection and ranging (RADAR) sensor, a light detection and ranging (LiDAR) sensor, a microphone, an ultrasound sensor, etc., to gather data and generate an image or movement details in the environment of the autonomous vehicle. However, other vehicles that are in proximity of the autonomous vehicle to connect with an infotainment broadcast system of the autonomous vehicle may also be in the environment of the autonomous vehicle and may receive traffic condition information from the autonomous vehicle based upon the data gathered using the perception technology of the autonomous vehicle.

The disclosed infotainment broadcast system installed in the autonomous vehicle may include, for example, a Wi-Fi hotspot or a Wi-Fi network system. The wireless communication equipment installed in the autonomous vehicle may be configured to establish a communication session with user equipment or smart vehicles using wireless protocols including, but not limited to, Wi-Fi, Bluetooth, 3G, 4G, LTE, 5G, 6G, etc. The disclosed embodiments use the Wi-Fi hotspot or the Wi-Fi network system as one example of wireless communication equipment; however, other types of wireless communication equipment may also be used.

The Wi-Fi hotspot or the Wi-Fi network system may broadcast its SSID information so that other mobile devices (such as phones, tablets, laptops, IOT devices, or smart glasses) or smart vehicle may establish connections with the Wi-Fi hotspot, or the Wi-Fi network system installed in the autonomous vehicle. Additionally, or alternatively, a connection with the Wi-Fi hotspot or the Wi-Fi network system may be made using a uniform resource locator (URL) address information provided to other drivers or road users using, for example, a machine-readable image (such as a quick response (QR) code or a barcode) or text visibly displayed on a body of the autonomous vehicle to other drivers or road users. Additionally, or alternatively, the URL address information may also be provided using a vehicle-to-vehicle interface or a network portal of a company owning the autonomous vehicle. Details of the network portal of the company may be visibly displayed on the body of the autonomous vehicle to other drivers or road users.

While the Wi-Fi hotspot or the Wi-Fi network system installed in a vehicle is generally available to users inside the vehicle, and mainly for accessing internet via the Wi-Fi hotspot or the Wi-Fi network system, the Wi-Fi hotspot or the Wi-Fi network system installed in the autonomous vehicle may be configured or adapted to transmit traffic condition information to other drivers on the road or other users of the roadway. In some embodiments, by way of a non-limiting example, the traffic condition information transmitted to other drivers on the road or other users of the roadway may be personalized or custom traffic condition information specific to a current position or movement of a vehicle of the other driver or road user. The personalized or custom traffic condition information may be displayed in a graphical user interface (GUI) of a mobile application (or a frontend application) executing on the user equipment of the other driver or road user requesting traffic condition information from the infotainment broadcast system of the autonomous vehicle. Additionally, or alternatively, the personalized or custom traffic condition information may be transmitted for being displayed as an image, a video, a graphics interchange format (GIF) file, or a text on the GUI.

In some embodiments, the personalized or custom traffic condition information may be generated based upon the other driver or road user identifying him or her, or his or her vehicle, based at least in part upon a position, a lane, a make and a model of his or her vehicle, etc., using an image transmitted to the mobile application upon successfully establishing a session with the infotainment broadcast system of the autonomous vehicle, or providing necessary details as selectable affordances or text inputs on a webpage. In some embodiments, and by way of a non-limiting example, the other driver or road user may also be required to provide additional information (e.g., a current speed of the vehicle) to authenticate and receive the personalized or custom traffic condition information.

Since the personalized or custom traffic condition information is generated and transmitted to the frontend application executing on the user equipment of the other driver or road user after a session is established with the infotainment broadcast system, the user equipment of the other driver or road user may be required to be within a coverage range of the Wi-Fi hotspot or the Wi-Fi network system, or within a communication coverage range of Bluetooth or other communication protocols. When a driver or a road user attempts to establish a session with the infotainment broadcast system of the autonomous vehicle, while being outside of a range of perception technology sensors of the autonomous vehicle, the driver or the road user may be notified that the personalized or custom traffic condition information is unavailable until the distance between the vehicle of the driver or road user in within a specific proximate distance of the autonomous vehicle.

In some embodiments, a unique tracking identification (ID) may be generated corresponding to each established session with the infotainment broadcast system of the autonomous vehicle. Additionally, each unique tracking ID may also identify or track a current position of the vehicle of the other driver or road user while the session remains established or active. By way of a non-limiting example, when the session may be automatically terminated after the session remains active or established for a predetermined duration (e.g., 15 minutes or 30 minutes). Based upon the tracked or identified current position of the vehicle of the other driver or road user, personalized or custom traffic condition information generated and displayed may include, but not limited to, (i) a number of vehicles in a specific distance in front of, or behind, the vehicle of the other driver or road user; (ii) an average speed of the vehicles in the specific distance in front of, or behind, the vehicle of the other driver or road user; (iii) an average speed of vehicles in other driving lanes; or (iv) a lane switching movement of vehicles in proximity of the vehicle of the other driver or road user, etc.

As described herein, the personalized or custom traffic condition information may be identified based upon data collected by sensors of the perception technology deployed on the autonomous vehicle. In some embodiments, and by way of a non-limiting example, an average speed of vehicles in a driving lane may be determined based on a speed of three vehicles. When determining the average speed of vehicle for a driving lane in which the vehicle of the other driver or road user is currently present, the average speed may be determined based on speed of one or two vehicles ahead of the vehicle, the vehicle of the other driver or road user, and one or two vehicles behind the vehicle. Based upon the average speed of each driving lane, the other driver or road user may be displayed information such as how much time the other driver or road user may save by switching to another driving lane.

In some embodiments, data corresponding to the personalized or custom traffic condition information may be transmitted to the user equipment of the other driver or road user periodically (e.g., every few seconds) or when there is a change in the traffic condition (e.g., a vehicle changing lane, increasing or decreasing vehicle speed). By way of a non-limiting example, certain changes in traffic condition (e.g., a vehicle exiting a highway) may not be communicated to the user equipment of the other driver or road user.

As described herein, the personalized or custom traffic condition information may be transmitted for being displayed as an image, a video, a graphics interchange format (GIF) file, or a text on the GUI. By way of a non-limiting example, a textual representation of the personalized or custom traffic condition information may be “The car that was in front of you stayed in the same lane and is now 100 feet ahead of your current position,” or “The car that behind you switched into your lane and is now 10 feet behind your current position.” A visual representation of the personalized or custom traffic condition information may include a stylized overview of the highway displaying vehicle positions or vehicle movements sensed in the environment of the autonomous vehicle corresponding to the personalized or custom traffic condition information for the driver or road user. Additionally, or alternatively, personal identifying information (PII) such as license plate information may be removed from the data transmitted to the user equipment of the other driver or road user. In some embodiments, color of other vehicles shown in the visual representation may be randomly selected to be different from the actual color of other vehicles. The visual representation may also include a respective speed of each vehicle displayed in the visual representation or a respective distance between two vehicles.

Exemplary traffic conditions that may be transmitted may further include the current speed of the autonomous vehicle, the speeds of other vehicles ahead of the autonomous vehicle in the same lane, the distance between the autonomous vehicle and another vehicle ahead of the autonomous vehicle in the same lane, accidents, road closure, or road blockage conditions, etc.

In some embodiments, and by way of a non-limiting example, the perception technology employed by the autonomous vehicle may collect traffic data using sensors of the perception technology to build a database of traffic patterns such as a number of vehicles on the road or in specific driving lanes during different times of the day, areas of the road where drivers generally change driving lanes, average speed of vehicles on the road during different times of the day, etc. The collected traffic data may be used to train a machine-learning model to predict traffic conditions or recommendations.

The Wi-Fi network system or the Wi-Fi hotspot system may be communicatively coupled with the central hub or the mission control over a 3G network, a 4G network, a 5G network, a 6G network, a WiMAX network, or a satellite network. Additionally, or alternatively, a public repeater infrastructure or a private repeater infrastructure may also be used by the Wi-Fi network system or the Wi-Fi hotspot system to connect with the central hub or the mission control.

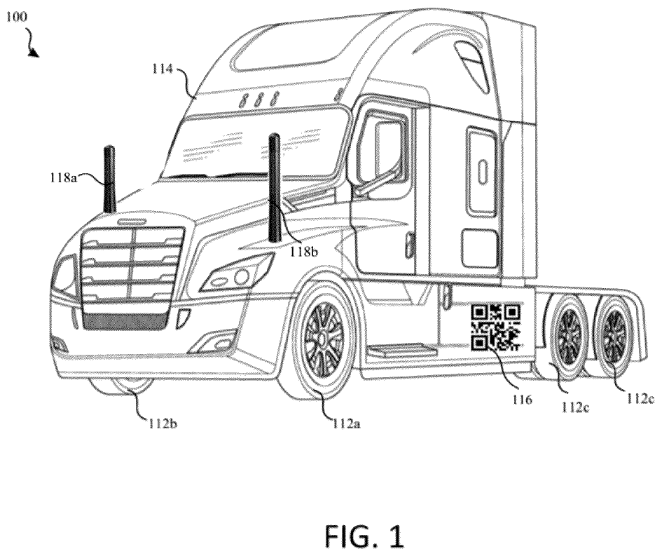

While the Wi-Fi network system or the Wi-Fi hotspot system is described using an autonomous vehicle, the embodiments described herein may be applicable to a non-autonomous vehicle or a semi-autonomous vehicle. Various features or embodiments described above are discussed in more detail below with respect to FIGS. 1-5.

FIG. 1 illustrates a vehicle 100 which may include a truck that may further be conventionally connected to a single or tandem trailer to transport the trailers (not shown) to a desired location. The vehicle 100 includes a cab 114 that can be supported by, and steered in, the required direction by front wheels 112a, 112b, and rear wheels 112c that are partially shown in FIG. 1. Wheels 112a, 112b are positioned by a steering system that includes a steering wheel and a steering column (not shown in FIG. 1). The steering wheel and the steering column may be located in the interior of cab 114. The steering wheel and the steering column may be omitted in an autonomous vehicle. The Wi-Fi network system or the Wi-Fi hotspot system described in the present disclosure may be located in the interior of cab 114 (not shown in FIG. 1). One or more antennas 118a, 118b may be positioned on the cab 114. By way of a non-limiting example, the one or more antennas 118a, 118b may be omnidirectional antennas, directional antennas, or sector antennas. The one or more antennas 118a, 118b may be positioned on the roof of the cab 114, on the hood of the cab 114, or inside the cab 114 such that the mobile devices or smart vehicles surrounding the autonomous vehicle may be provided services through the Wi-Fi network system or the Wi-Fi hotspot system. A QR code 116 may be positioned on one or more sides of the vehicle 100, as shown in FIG. 1. Additionally, or alternatively, an SSID of the Wi-Fi network system or the Wi-Fi hotspot, or a network portal address may also be provided on one or more sides of the vehicle 100. The QR code 116, the SSID, and the network portal address may be referenced herein as indicia for connecting to the Wi-Fi network system or the Wi-Fi hotspot system. Sensors of the perception technology may be mounted, or positioned, on various locations on the body of the vehicle 100 to capture data corresponding to sensing objects in the environment of the vehicle 100. As described herein, sensors of the perception technology may include one or more cameras, one or more LiDAR sensors, one or more RADAR sensors, one or more ultrasound sensors, one or more microphones, etc.

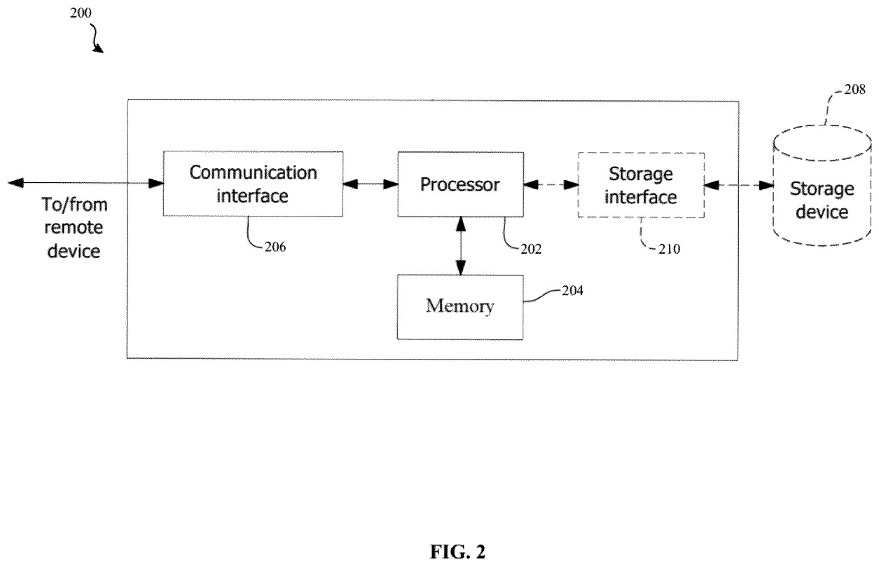

FIG. 2 is an exemplary schematic block diagram of a computing device 200 for implementation of embodiments of the present disclosure. The computing device 200 may be the Wi-Fi network system and the Wi-Fi hotspot system described herein. The computing device 200 may include one or more processing units or processors 202 (e.g., in a multi-core configuration). Processor 202 may be operatively coupled to a communication interface 206 such that the computing device 200 is capable of communicating with another device, such as a remote application server, a user equipment, a mobile device, a smart vehicle, a mission control or a central hub, or another computing device, for example, using wireless communication or data transmission over one or more radio links or digital communication channels using one or more of a Wi-Fi protocol, an RFID protocol, or a Near-Field Communication (NFC) protocol, as one-way communication or two-way communication.

Processor 202 may also be operatively coupled to a storage device 208. Storage device 208 may be any computer-operated hardware suitable for storing or retrieving data, such as, but not limited to, data associated with historic databases. In some embodiments, storage device 208 may be integrated in the computing device 200. For example, the computing device 200 may include one or more hard disk drives as storage device 208.

In other embodiments, storage device 208 may be external to the computing device 200 and may be accessed by a using a storage interface 210. For example, storage device 208 may include a storage area network (SAN), a network attached storage (NAS) system, or multiple storage units such as hard disks or solid-state disks in a redundant array of inexpensive disks (RAID) configuration.

In some embodiments, processor 202 may be operatively coupled to storage device 208 via the storage interface 210. Storage interface 210 may be any component capable of providing processor 202 with access to storage device 208. Storage interface 210 may include, for example, an Advanced Technology Attachment (ATA) adapter, a Serial ATA (SATA) adapter, a Small Computer System Interface (SCSI) adapter, a RAID controller, a SAN adapter, a network adapter, or any component providing processor 202 with access to storage device 208.

The processor 202 may execute computer-executable instructions for implementing aspects of the disclosure. In some embodiments, the processor 202 may be transformed into a special purpose microprocessor by executing computer-executable instructions or by otherwise being programmed. In some embodiments, and by way of a non-limiting example, the memory 204 may include instructions to perform specific operations, as described herein.

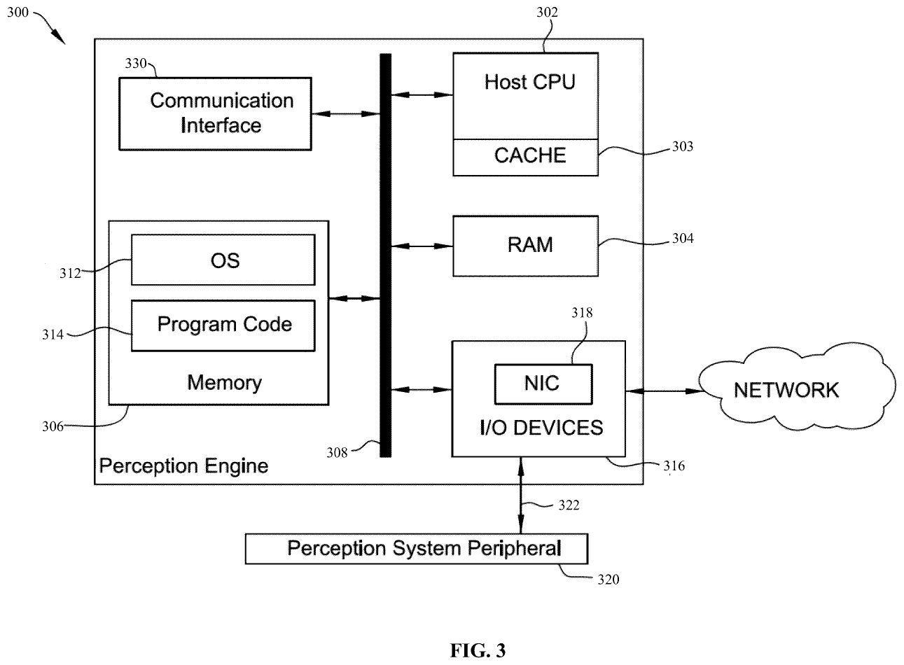

FIG. 3 is a block diagram of an example perception system 300 for sensing an environment in which a vehicle is positioned. Perception system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. In alternative embodiments, one or more section of memory 306 may be omitted and the data stored remotely. For example, in certain embodiments, program code 314 may be stored remotely on a server or mass-storage device and made available over a network 332 to CPU 302.

Perception system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for operating a display peripheral over a display link, a serial channel controller or other suitable interface for controlling a sensor peripheral such as one or more acoustic sensors, a LiDAR sensor or a camera, or a CAN bus controller for communicating over a CAN bus.

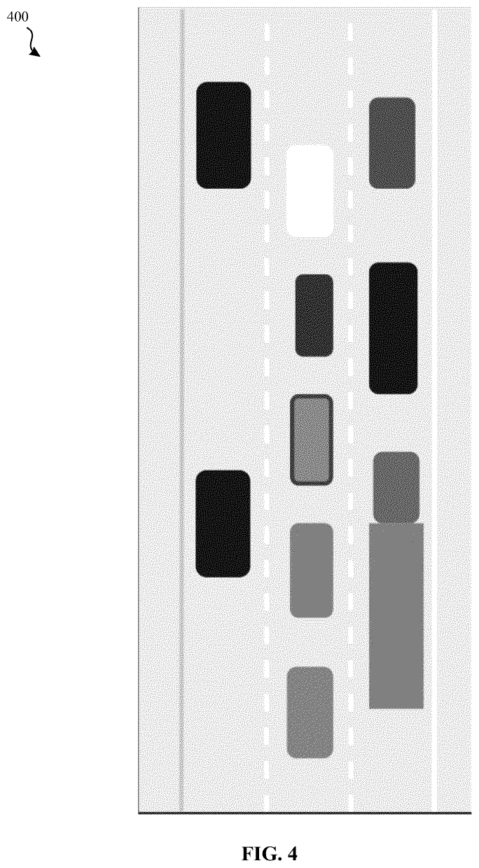

FIG. 4 is an exemplary view 400 of a visual representation of personalized or custom traffic condition information displayed in a graphical user interface of a frontend application executing on a user equipment. The visual representation of the personalized or custom traffic condition information may include a stylized overview of the highway displaying vehicle positions or vehicle movements sensed in the environment of the autonomous vehicle corresponding to the personalized or custom traffic condition information for the driver or road user. Additionally, or alternatively, personal identifying information (PII) such as license plate information may be removed from the data transmitted to the user equipment of the other driver or road user. In some embodiments, color of other vehicles shown in the visual representation may be randomly selected to be different from the actual color of other vehicles. The visual representation may also include a respective speed of each vehicle displayed in the visual representation or a respective distance between two vehicles, or a distance between two consecutive vehicles.

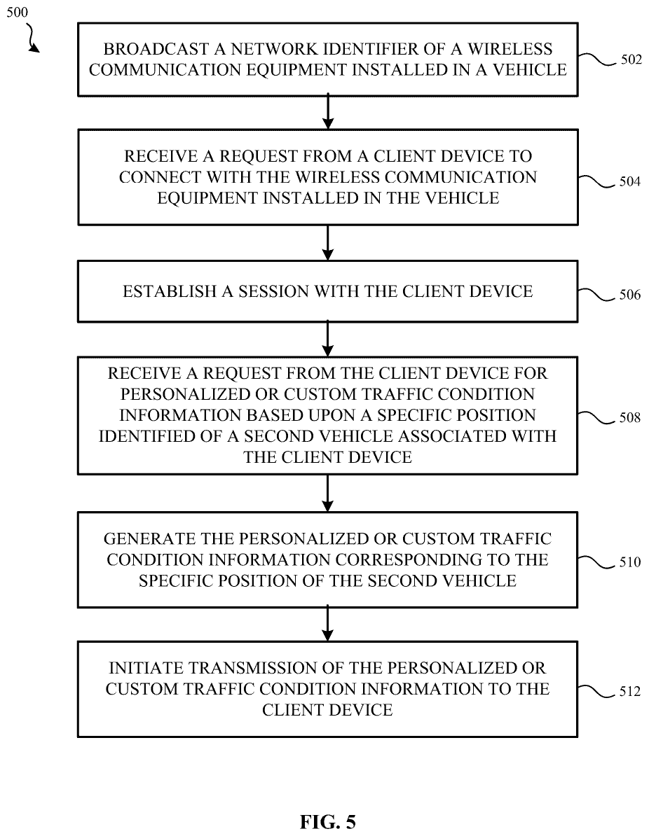

FIG. 5 is a flow chart that comprises an exemplary method 500 of transmitting personalized or custom traffic condition information from an infotainment broadcast system installed in a vehicle to a user equipment of another driver or road user, in accordance with embodiments of the present disclosure. By way of a non-limiting example, the user equipment may be a Wi-Fi enabled client device. As shown in FIG. 5, and as described herein, a vehicle may broadcast 502 a network identifier of a wireless communication equipment installed in the vehicle. By way of a non-limiting example, the wireless communication equipment may be a Wi-Fi network system or a Wi-Fi hotspot system. The network identifier may be a name of the wireless communication equipment. In case the wireless communication equipment is the Wi-Fi network or the Wi-Fi hotspot system, the network identifier may be a service set identifier. The wireless communication equipment installed in the vehicle may also be referenced herein as the vehicle wireless communication equipment. The broadcasted network identifier may be received by the client device, and a user of the client device may initiate and transmit a request to connect with the wireless communication equipment. In some embodiments, the client device may automatically generate and transmit the request to connect with the wireless communication equipment.

The vehicle receives 504 the request transmitted from the client device, based on the broadcasted network identifier, or an indicium displayed on a body of the vehicle 100. By way of a non-limiting example, the indicium displayed on the body of the vehicle 100 may include a machine readable image, such as a QR code, a network identifier, or an SSID of the Wi-Fi network system or the Wi-Fi hotspot system. The machine readable image may be scanned by the client device. In response to receiving 504 the request, a session is established 506 between the wireless communication equipment and the client device.

The vehicle receives 508 a request from the client device for personalized or custom traffic condition information based upon a specific position identified of a vehicle associated with the client device. The vehicle associated with the client device may be referenced herein as a second vehicle. The specific position of the second vehicle may be identified based upon an image transmitted to the client device showing a plurality of vehicles and a respective position of each vehicle of the plurality of vehicles in proximity of the vehicle. The plurality of vehicles and the respective position of each vehicle of the plurality of vehicle is determined by a perception system based upon sensor data of a plurality of sensors of the perception system. Additionally, or alternatively, the specific position of the second vehicle associated with the client device may be identified based upon a confirmation provided by a user of the client device, where the confirmation may include a user input of a current speed of the second vehicle.

Based upon sensor data of a plurality of sensors of a perception system of the vehicle, the personalized or custom traffic condition information corresponding to the specific position of the second vehicle may be generated 510 and transmitted 512 to the client device over the established session. The personalized or custom traffic condition information may include at least one of: (i) a number of vehicles in a specific distance in front of, or behind, the second vehicle in a driving lane of the second vehicle; (ii) an average speed of one or more vehicles in the specific distance in front of, or behind, the second vehicle in the driving lane of the second vehicle; (iii) an average speed of vehicles in one or more driving lanes different from the driving lane of the second vehicle; (iv) a lane switching movement of vehicles in proximity of the second vehicle; or (v) a current speed of one or more vehicles in proximity of the second vehicle. The personalized or custom traffic condition information may be transmitted as a text, an image, a video, or a graphics interchange format (GIF) file. Additionally, or alternatively, the personalized or custom traffic condition information may be transmitted periodically or in response to an event requiring an update to the personalized or custom traffic condition information, the event comprises at least one vehicle changing its respective driving lane or a change in an average speed of vehicles in any driving lane.

The client device as described herein may include a user equipment, a mobile device, a tablet, a smartwatch, a laptop, a smart glass, an internet-of-things (IOT) device, or a smart vehicle. The vehicle may be an autonomous vehicle, a semi-autonomous vehicle, or a non-autonomous vehicle.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A vehicle, comprising:
a vehicle wireless communication equipment;
a perception system comprising at least one processor, at least one memory configured to store instructions, and a plurality of sensors positioned, or mounted, on a body of the vehicle; and
an indicium for connecting to the vehicle wireless communication equipment, the indicium displayed on the body of the vehicle and the indicium including information to connect with the vehicle wireless communication equipment, wherein:
the vehicle wireless communication equipment is configured to:
broadcast a network identifier of the vehicle wireless communication equipment;
receive a request, from a third-party client device, to connect with the vehicle wireless communication equipment based upon the broadcasted network identifier or the indicium for connecting to the vehicle wireless communication equipment;
in response to the received request, establish a session with the third-party client device; and
receive a request from the third-party client device to receive personalized or custom traffic condition information based upon a specific position identified of a second vehicle associated with the third-party client device;
the at least one processor of the perception system is configured to:
based upon sensor data of the plurality of sensors of the perception system, generate the personalized or custom traffic condition information corresponding to the specific position of the second vehicle; and
initiate transmission of the personalized or custom traffic condition information corresponding the specific position of the second vehicle to the third-party client device via the vehicle wireless communication equipment over the established session.

2. The vehicle of claim 1, wherein the specific position of the second vehicle associated with the third-party client device is identified based upon an image transmitted to the third-party client device showing a plurality of vehicles and a respective position of each vehicle of the plurality of vehicles in proximity of the vehicle, the plurality of vehicles and the respective position of each vehicle of the plurality of vehicle is determined by the at least one processor of the perception system based upon the sensor data of the plurality of sensors of the perception system.

3. The vehicle of claim 2, wherein the specific position of the second vehicle associated with the third-party client device is identified based upon a confirmation provided by a user of the third-party client device, the confirmation including a user input of a current speed of the second vehicle.

4. The vehicle of claim 1, wherein the personalized or custom traffic condition information includes at least one of: (i) a number of vehicles in a specific distance in front of, or behind, the second vehicle in a driving lane of the second vehicle; (ii) an average speed of one or more vehicles in the specific distance in front of, or behind, the second vehicle in the driving lane of the second vehicle; (iii) an average speed of vehicles in one or more driving lanes different from the driving lane of the second vehicle; (iv) a lane switching movement of vehicles in proximity of the second vehicle; or (v) a current speed of each vehicle in proximity of the second vehicle.

5. The vehicle of claim 1, wherein the personalized or custom traffic condition information is transmitted as a text, an image, a video, or a graphics interchange format (GIF) file.

6. The vehicle of claim 1, wherein the personalized or custom traffic condition information is transmitted periodically or in response to an event requiring an update to the personalized or custom traffic condition information.

7. The vehicle of claim 6, wherein the event comprises at least one vehicle changing its respective driving lane or a change in an average speed of vehicles in any driving lane.

8. The vehicle of claim 1, wherein the plurality of sensors includes one or more cameras, one or more radio detection and ranging (RADAR) sensors, one or more light detection and ranging (LiDAR) sensors, one or more microphones, or one or more ultrasound sensors.

9. The vehicle of claim 1, wherein the indicium for connecting to the wireless communication equipment displayed on the body of the vehicle includes a quick response (QR) code or network identifier.

10. The vehicle of claim 1, wherein the vehicle is an autonomous vehicle, a semi-autonomous vehicle, or a non-autonomous vehicle.

11. A method of transmitting personalized or custom traffic condition information from a vehicle to a client device, the method comprising:
broadcasting a network identifier of a wireless communication equipment installed in the vehicle;
receiving a request, from the client device, to connect with the wireless communication equipment based upon the broadcasted network identifier or scanning of an indicium displayed on a body of the vehicle by the client device;
in response to receiving the request, establishing a session with the client device;
receiving a request from the client device for personalized or custom traffic condition information based upon a specific position identified of a second vehicle associated with the client device;
based upon sensor data of a plurality of sensors of a perception system of the vehicle, generating the personalized or custom traffic condition information corresponding to the specific position of the second vehicle; and
transmitting, to the client device, the personalized or custom traffic condition information over the established session.

12. The method of claim 11, wherein the specific position of the second vehicle associated with the client device is identified based upon an image transmitted to the client device showing a plurality of vehicles and a respective position of each vehicle of the plurality of vehicles in proximity of the vehicle, the plurality of vehicles and the respective position of each vehicle of the plurality of vehicle is determined by the perception system based upon the sensor data of the plurality of sensors of the perception system.

13. The method of claim 12, wherein the specific position of the second vehicle associated with the client device is identified based upon a confirmation provided by a user of the client device, the confirmation including a user input of a current speed of the second vehicle.

14. The method of claim 11, wherein the personalized or custom traffic condition information includes at least one of: (i) a number of vehicles in a specific distance in front of, or behind, the second vehicle in a driving lane of the second vehicle; (ii) an average speed of one or more vehicles in the specific distance in front of, or behind, the second vehicle in the driving lane of the second vehicle; (iii) an average speed of vehicles in one or more driving lanes different from the driving lane of the second vehicle; (iv) a lane switching movement of vehicles in proximity of the second vehicle; or (v) a current speed of one or more vehicles in proximity of the second vehicle.

15. The method of claim 11, wherein the personalized or custom traffic condition information is transmitted as a text, an image, a video, or a graphics interchange format (GIF) file.

16. The method of claim 11, wherein the personalized or custom traffic condition information is transmitted periodically or in response to an event requiring an update to the personalized or custom traffic condition information, the event comprises at least one vehicle changing its respective driving lane or a change in an average speed of vehicles in any driving lane.

17. The method of claim 11, wherein the plurality of sensors includes one or more cameras, one or more radio detection and ranging (RADAR) sensors, one or more light detection and ranging (LiDAR) sensors, one or more microphones, or one or more ultrasound sensors.

18. The method of claim 11, wherein the indicium for connecting to the wireless communication equipment displayed on the body of the vehicle includes a quick response (QR) code or the network identifier.

19. The method of claim 11, wherein the vehicle is an autonomous vehicle, a semi-autonomous vehicle, or a non-autonomous vehicle.

20. A vehicle, comprising:
a vehicle wireless communication equipment;
at least one processor;
at least one memory configured to store instructions;
a plurality of perception sensors positioned, or mounted, on a body of the vehicle; and
an indicium for connecting to the vehicle wireless communication equipment, the indicium displayed on the body of the vehicle and the indicium including information to connect with the vehicle wireless communication equipment, wherein:
the vehicle wireless communication equipment is configured to:
broadcast a network identifier of the vehicle wireless communication equipment;
receive a request, from a third-party client device, to connect with the vehicle wireless communication equipment based upon the broadcasted network identifier or the indicium for connecting to the vehicle wireless communication equipment;
in response to the received request, establish a session with the third-party client device; and
receive a request from the third-party client device to receive personalized or custom traffic condition information based upon a specific position identified of a second vehicle associated with the third-party client device; and
the at least one processor is configured to execute the stored instructions to:
based upon sensor data of the plurality of perception sensors, generate the personalized or custom traffic condition information corresponding to the specific position of the second vehicle; and
cause transmission of the personalized or custom traffic condition information corresponding the specific position of the second vehicle to the third-party client device via the vehicle wireless communication equipment over the established session.
